(19) United States
(12) Patent Application Publication
(10) Pub. No.: US 2016/0249626 A1
(43) Pub. Date: Sep. 1, 2016

(54) DEVICE FOR FORMING A CONTINUOUS STRIP OF DOUGH

(71) Applicant: KOENIG MASCHINEN GESELLSCHAFT M.B.H., Graz (AT)

(72) Inventors: Thomas Rieger, Lieboch (AT); Peter Thomasser, Gleisdorf (AT); Willibald Rabenhaupt, Deutschfeistritz (AT)

(21) Appl. No.: 14/907,261

(22) PCT Filed: Jul. 22, 2014
(86) PCT No.: PCT/AT2014/050161

§ 371 Date: May 3, 2016

(30) Foreign Application Priority Data
Jul. 22, 2013 (AT) A 50462/2013

(51) Int. Cl. A21C 3/02; A21C 11/10

(52) U.S. Cl. CPC A21C 3/02; A21C 11/10; A23L 1/0073; A23V 2002/00

(57) ABSTRACT

The invention relates to a device and a method for forming a continuous strip of dough. According to the invention, it is provided that the device (10) comprises a dough chamber (2), which is defined, in sections, by a discharge belt (3) for conveying dough towards a cutting device (4) for limiting the thickness of the strip of dough, where in this case said cutting device (4) is mounted at a distance above the discharge belt (3).

The present invention relates to a device for forming a continuous strip of dough according to the preamble of patent claim 1 and to a method for forming a continuous strip of dough according to patent claim 27.

The prior art discloses a wide range of devices and methods, with which the shape of the dough can be changed and with which dough pieces or individual pieces of pastry can be produced from this dough. In the food industry strips of dough are produced in order to produce pieces of pastry or to sell individual dough sheets or dough rolls.

A very simple method consists of producing a contiguous and continuous strip of dough by prefabricating individual dough pieces either by hand or with dough star rollers, by placing these dough pieces in a row and then connecting with a certain degree of overlap by pressing said dough pieces against each other using mechanical means. The overlapping points and the abutting points of the dough are a drawback with this method, because the net result is an uneven structure of the dough, and the desired weight accuracy is difficult to achieve in these areas. In order to compensate for this non-uniformity in the dough, expensive equipment for finishing the strip of dough that is produced in this way are necessary. For example, the dough has to be further formed and smoothed out by means of kneading drums or processing systems.

Another drawback with the prior art methods and devices is that the additional steps to make the strip of dough uniform are time consuming, and, as a result, the production costs and the cost of the individual devices increase significantly.

Therefore, the object of the present invention is to provide a device of the type described in the introductory part, where in this case the device makes it possible to produce a continuous and uniform strip of dough, in particular, in one step and without additional devices, so that further processing is not required.

This object is achieved by the characterizing features of claim 1, where it is provided that the device comprises a dough chamber, which is defined in sections by a discharge belt for conveying dough towards a cutting device for limiting the thickness of the strip of dough, where in this case the cutting device is mounted at a distance above the discharge belt.

The dough in the dough chamber is delivered by the discharge belt to the cutting device, is moved up to said cutting device and is cut off by the cutting device at a defined distance from the discharge belt. This arrangement makes it possible to produce a strip of dough having a uniform density and structure and having a height that is constant over the length of the strip of dough. A uniform strip of dough typically has the same thickness over its entire length, with said thickness being equivalent to the height. Similarly, when the strip of dough is uniform, the density or consistency of the strip of dough along the cross section and its length is usually the same.

Particularly advantageous embodiments of the device are defined in greater detail by the features of the dependent claims.

In order to specify the width of the strip of dough in a better way, it is provided that two opposite, rotatably mounted limiting plates are provided, wherein the limiting plates define the dough chamber laterally.

The width of the strip of dough is especially uniform, if the limiting plates rest on or against the discharge belt.

One advantageous embodiment of the dough chamber and the device is achieved, if the limiting plates are oriented perpendicular to the surface of the discharge belt, and/or that the dough chamber is designed in the shape of a cylinder, and/or the limiting plates are designed so as to be round.

An advantageous orientation of the dough chamber is achieved by arranging the axis of the cylindrical dough chamber horizontally and parallel to the surface of the discharge belt.

The manufacturing costs of the device are reduced, and an even more uniform strip of dough can be produced, if the limiting plates have the same diameter and are aligned parallel and concentrically to each other.

Since the distance between the limiting plates defines the width of the strip of dough, it is provided in an advantageous way that the distance, in particular, the normal distance, of the two limiting plates from each other can be adjusted in order to adjust the width of the strip of dough.

The width of the strip of dough may be adjusted while the system is running or even before the system is put into operation, if the two limiting plates can be moved, independently or coupled, preferably synchronously, toward each other.

More dough can be stored in the device, and the intensity, with which the production has to be attended, and, thus, the labor costs in the plant can be reduced, if a number of connecting parts are provided. These connecting parts can be connected to the limiting plates in their peripheral region, are preferably aligned parallel to the limiting plates, and define the dough chamber.

The gravitational forces can convey in a supportive fashion the dough in the direction of the discharge belt, if the discharge belt is arranged in the region of the dough chamber that is located at the bottom during use.

In order to change the setting of the height of the strip of dough while the system is running or even when the device is used to produce a new strip of dough, it is provided that the cutting device has a cutting edge, and that the distance of the cutting edge of the cutting device from the discharge belt is adjustable, in order to set the height of the strip of dough.

The entry of the cutting device into the dough chamber can be prevented, if the cutting device is mounted in such a way that it can pivot about the central axis of the limiting plates.

A uniform thickness over the entire cross section of the strip of dough can be achieved, if the cutting edge of the cutting device extends transversely to the direction of movement of the discharge belt and parallel to the surface of the discharge belt.

In order to change the position of the cutting device and, in so doing, the position of the cutting point, it is provided that the cutting edge of the cutting device is linearly adjustable in the cutting plane. The cutting plane is understood to mean the plane defined by the angle bisector between the upper and lower cutting surface of the cutting device.

The strip of dough may be cut off along its entire width, and, hence, it is possible to achieve a uniform height profile of the strip of dough, if the cutting device has at least the same width as or a greater width than the, preferably maximum, internal distance between the limiting plates.

The dough may be cut off extremely well and evenly, if the cutting device is designed as an oscillating hacksaw, an oscillating knife or an ultrasonic cutting device.

In order to further define the dough chamber and to keep excess dough in the dough chamber, it is provided that at least one limiting belt is provided. In this case said limiting belt is connected, in particular, directly to the cutting device, when viewed in the direction of rotation of the limiting plates, and defines the dough chamber.

The dough chamber may be defined extremely well and may prevent the dough from oozing out between the limiting belt, the discharge belt and the limiting plates, if the discharge belt and/or the limiting belt loop(s), in particular, in sections, around the limiting plates, preferably on the periphery thereof, and/or can be brought into contact with the connecting parts.

The tightness of the dough chamber against the dough oozing out can be improved, if the contact pressure of the discharge belt and/or the limiting belt can be predetermined by means of the arrangement of the limiting plates, the connecting parts and/or the guide rollers.

A simple conveying of the dough to the cutting device provides that a drive is provided, and that the discharge belt, the limiting belt and/or the limiting plates can be driven by this drive.

The drive can be connected to the driven parts in a very easy way, if the discharge belt and/or the limiting belt comprise(s) at least one drive roller, where in this case the drive roller is connected to the drive by means of chains, belts or toothed belts.

A simple way of operating the limiting plates and the limiting belt or the discharge belt in a synchronous fashion is achieved by connecting in a movement coupled manner the limiting plates on their periphery to the discharge belt and/or to the limiting belt by means of a friction grip or by means of teeth that are formed on the periphery of the limiting plates.

The limiting plates can be mounted extremely well in the device, if a housing is provided, and the limiting plates, the guide rollers or the drive rollers are mounted in the housing in a manner allowing rotation, in particular, in a floating manner.

It is also particularly advantageous, if the housing has a rigid frame structure, where in this case the limiting plates are mounted in the rigid frame structure.

Easier cleaning of the device and the dough chamber can be achieved, if the rigid frame structure and/or the housing comprise(s) a number of hinges, and/or at least one of the limiting plates and/or the connecting parts can be detached or swung away from the rigid frame structure with the hinges, in order to facilitate the cleaning of the dough chamber.

Dislodging the dough from the limiting plates is supported and facilitated, if a number of devices for producing a film of oil and/or flour dusting devices are provided, with which edible oil or flour can be applied to the inner faces of the limiting plates and/or to the limiting belt and/or to the discharge belt as an anti-sticking agent.

One advantageous method for forming a continuous strip of dough provides that dough is delivered into a dough chamber, and dough is conveyed continuously by a discharge belt toward a cutting device, and the cutting device cuts off the dough at a distance from the discharge belt at a predetermined height, and that the dough portion of the conveyed amount of dough, which exceeds a predetermined height and which was cut off with the cutting device, is conveyed, in particular, back into the dough chamber or is retained in the dough chamber, and the severed strip of dough is discharged from the dough chamber.

In order to be able to run the process continuously, it is advantageously provided that in a preparation step portions of dough are introduced into the dough chamber, where they are connected to form a dough mass.

It is particularly advantageous, if the cut of the cutting device is carried out transversely and parallel to the direction of movement of the discharge belt.

Additional advantages and embodiments of the invention will become apparent from the description and the accompanying drawings.

The invention is shown below in schematic form in the drawings by means of particularly advantageous embodiments, which, however, are not to be construed as limiting, and said invention will be described by way of example with reference to the drawings.

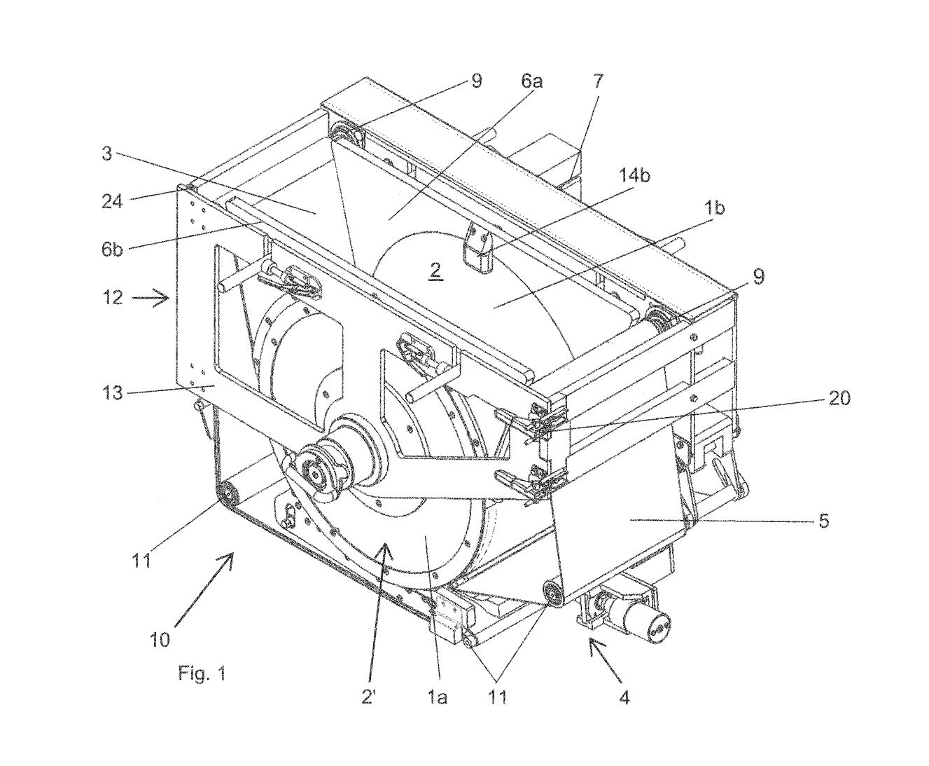

FIG. 1 shows a perspective view of the device.

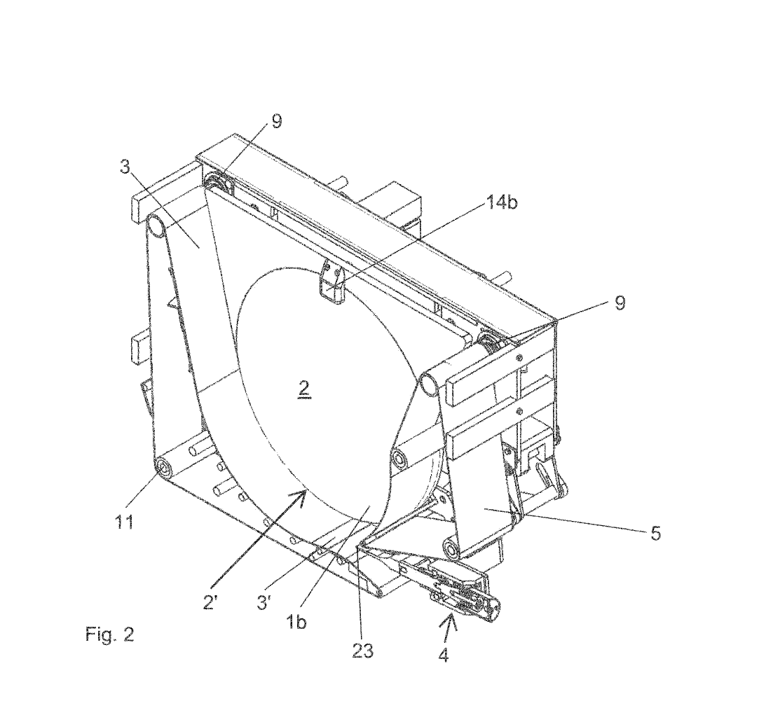

FIG. 2 shows a longitudinal section of the device in a perspective view.

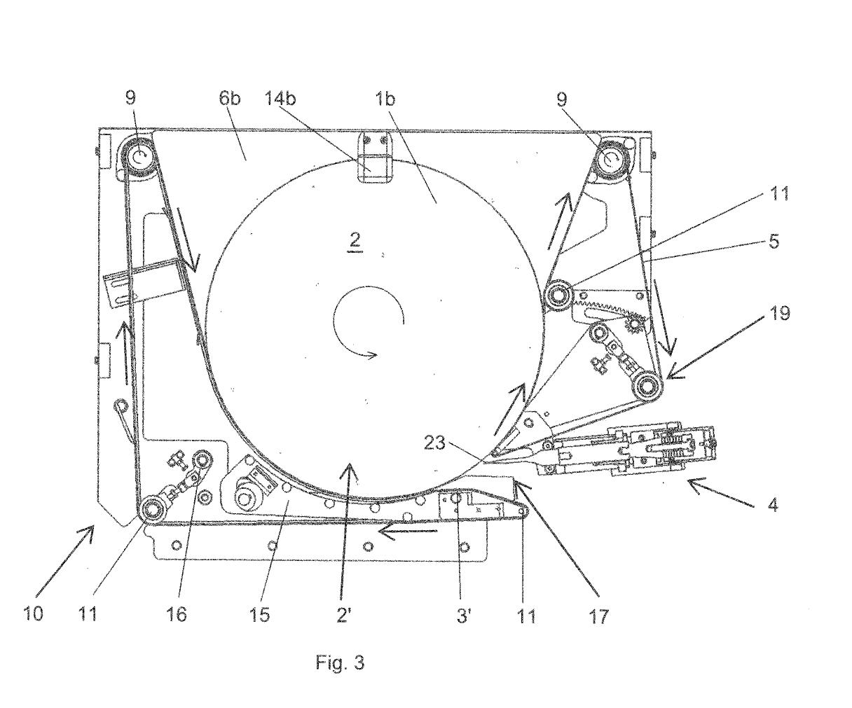

FIG. 3 shows a sectional view of the device.

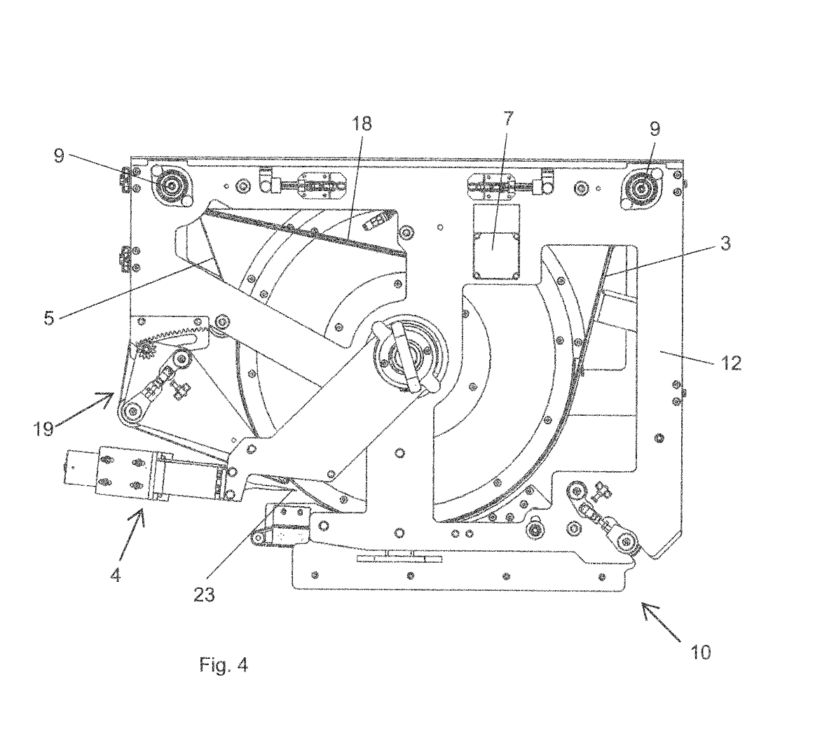

FIG. 4 shows a view of the drive side of the device.

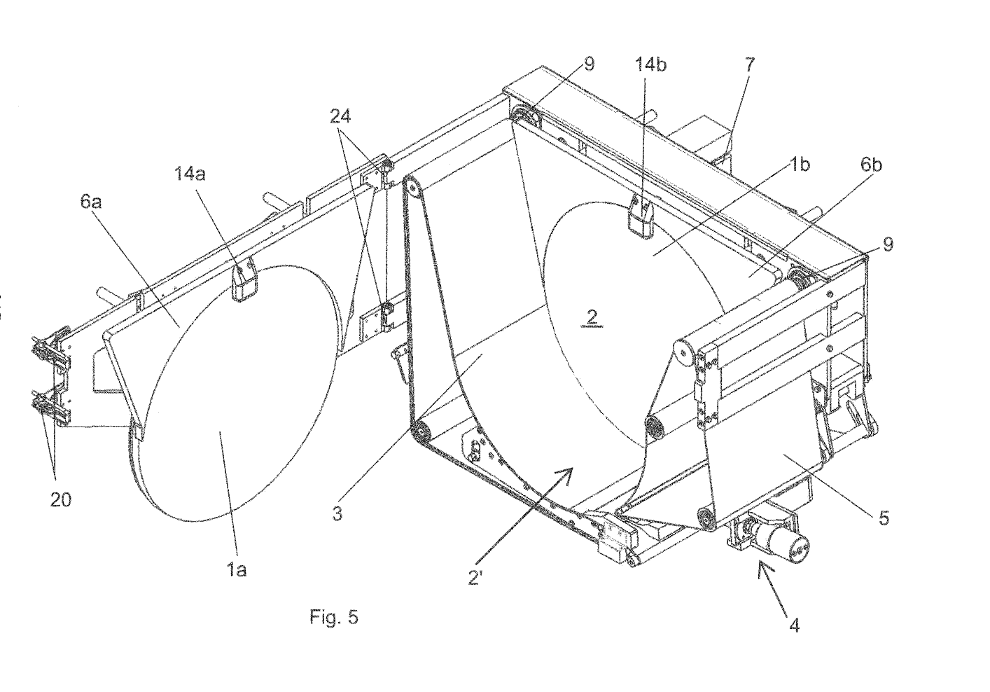

FIG. 5 shows a perspective view of the device in the unfolded state.

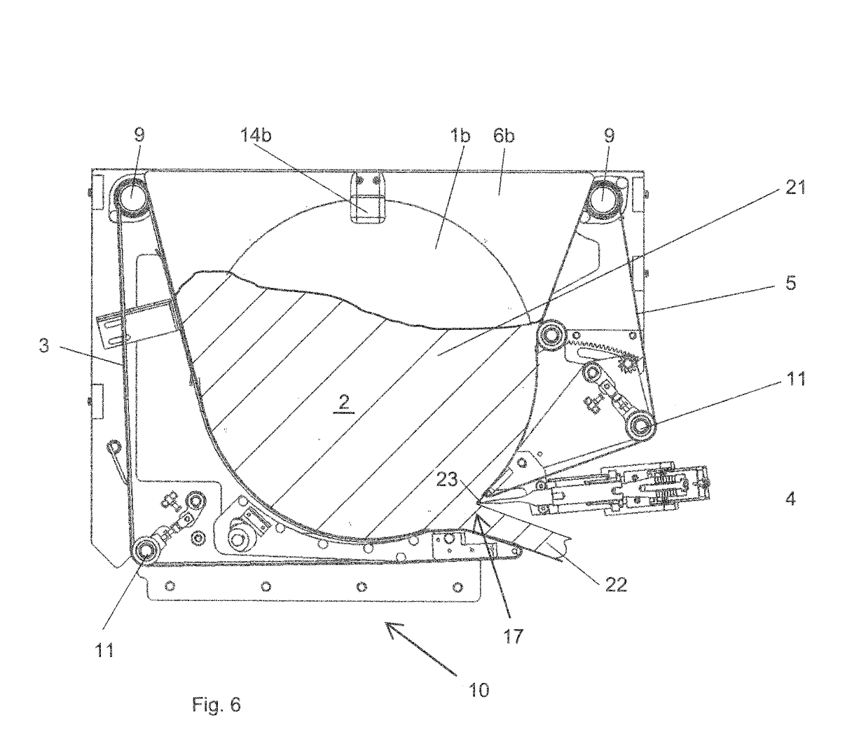

FIG. 6 shows a sectional view of the device while the device is running.

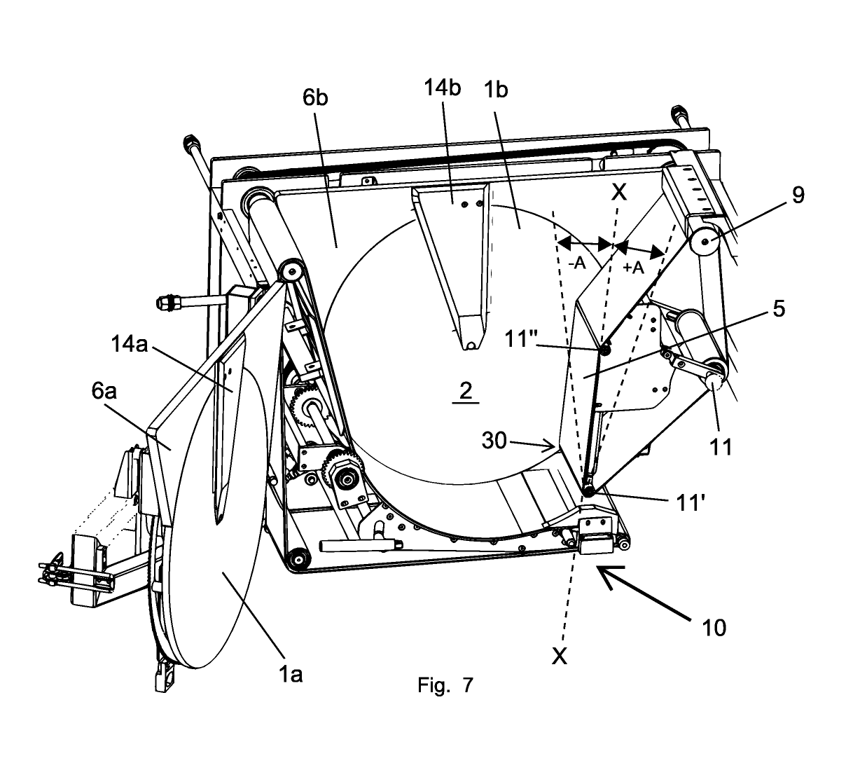

FIG. 7 shows a perspective view of an alternative embodiment of the invention.

FIG. 1 shows a perspective view of the device according to the invention. The device 10 comprises a dough chamber 2, which is defined by a discharge belt 3 predominantly in its lower region 2′. Furthermore, the dough chamber 2 is defined laterally by two limiting plates 1a, 1b, which are mounted in such a way that they can rotate freely.

The limiting plates 1a, 1b have the same diameter and are designed as cylindrical disks. The limiting plates 1a, 1b are aligned parallel and concentrically to each other and, thus, form the lateral limits of the dough chamber 2, which is designed in the shape of a cylinder between said limiting plates. The limiting plates 1a, 1b are oriented in the vertical plane. The dough chamber 2 can be extended by means of connecting parts 6a, 6b, which are connected to the limiting plates 1a, 1b, in that the dough chamber 2 in this embodiment is designed in the form of a prism, with the apex of the prism pointing in the direction of the bottom of the device 10 and with its apex being rounded off by means of the discharge belt 3. The cylinder axes of the limiting plates 1a, 1b and, thus, the axis of the prismatic dough chamber 2 are arranged horizontally. In the lower region 2′ of the dough chamber 2 a cutting device 4 is disposed above the discharge belt 3. The cutting device 4 is located above the discharge belt 3 and has a greater width than the inner distance between the limiting plates 1a, 1b.

Furthermore, FIG. 1 shows a limiting belt 5, which defines the dough chamber 2. The limiting belt 5 is disposed above the cutting device 4 and is connected directly, when viewed in the direction of rotation of the limiting plates 1a, 1b, to the cutting device 4 (FIG. 2).

The dough chamber 2 is defined laterally by means of the limiting plates 1a, 1b and the connecting parts 6a, 6b. On the peripheral side the dough chamber 2 is partially defined by the limiting belt 5 and partially by the discharge belt 3. The dough chamber 2 is designed so as to be open at the top, where in this case the dough can be introduced through this opening into the device 10 or more specifically into the dough chamber 2. Furthermore, the device 10 has a housing 12. An essential component of the housing 12 is a rigid frame structure 13, in which the limiting plates 1a, 1b are mounted in a manner allowing rotation.

The limiting plates 1a, 1b can be adjusted relative to each other along their cylinder axis, where in this case their normal spacing can be varied in order to adjust the width of the strip of dough. The two limiting plates 1a, 1b are rotatably mounted on a radial bearing in the rigid frame structure 13 in such a way that they can be moved axially along their axis of rotation. At the same time the distance of the two limiting plates 1a, 1b from each other can be adjusted independently of each other or coupled to each other. The limiting plates 1a, 1b can be adjusted synchronously or also independently of each other. The change in the normal spacing of the two limiting plates 1a, 1b and in this embodiment also the connecting parts 6a, 6b affects a change in the width of the strip of dough 22. If the normal spacing is reduced, then the width of the strip of dough 22 decreases, and if the normal spacing is increased, then the width of the strip of dough 22 increases. In this respect the distance of the limiting plates 1a, 1b from each other can be changed mechanically, in particular, by means of hydraulic actuating means, or by manual adjustments.

FIG. 2 shows a perspective sectional view of the device 10. The cut is carried out parallel to the limiting plate 1b through the dough chamber 2. Furthermore, FIG. 2 shows a device 14b for producing a film of oil. With this oiling device 14b the limiting plate 1b may be sprinkled with oil on the inner surface, so that it is easier to peel the dough from the limiting plate 1b. The devices for producing a film of oil 14a and 14b may be formed multiple times, distributed over the periphery, on the limiting plates 1a, 1b.

FIG. 3 shows a side view of the device 10 in a cross section with the cut performed in the same way as in FIG. 2. FIG. 3 shows the course of the limiting belt 5 and the discharge belt 3. The discharge belt 3 is brought into contact, as also shown in FIG. 2, with the connecting parts 6a or 6b respectively (FIG. 1) and the limiting plates 1a, 1b. The limiting belt 5 is connected just as well to the limiting plates 1a, 1b and the connecting parts 6a, 6b. The discharge belt 3 and the limiting belt 5 loop around the limiting plates 1a, 1b over a section of the periphery. Furthermore, FIG. 3 shows guide rollers 11, which define the course of the discharge belt 3 and the limiting belt 5, and determine by means of their position the contact pressure of the discharge belt 3 and the limiting belt 5 at the limiting plates 1a, 1b and the connecting parts 6a, 6b. FIG. 3 shows in schematic form the direction of travel of the belt or rather the direction of rotation of the limiting plates 1a, 1b. The discharge belt 3 is moved in the clockwise direction by means of a drive roller 9 disposed in the upper region of the device 10. Similarly a drive roller 9, which defines the movement of the limiting belt 5 in the clockwise direction, is provided at the limiting belt 5. The rotatably mounted limiting plates 1a, 1b are driven by means of the limiting belt 5, which is brought into contact with the limiting plates 1a, 1b, and the discharge belt 3, and are then rotated along with the belts. At the same time the limiting plates 1a, 1b turn in the counterclockwise direction. The contact pressure of the limiting belt 5 and the discharge belt 3 is determined by means of the guide rollers 11, 11′, 11″. The guide rollers 11, 11′, 11″ have actuating devices 16 and tensioning devices 15, which adjust the contact pressure of the discharge belt 3 and the limiting belt 5 and tighten said belts and optionally predetermine or more specifically adjust their position. In so doing, the contact pressure of the belts on the limiting plates 1a, 1b is chosen in such a way that the limiting plates 1a, 1b do not slip at the limiting belt 5 and the discharge belt 3 and are driven by the limiting belt 3 or the discharge belt 3 due to the friction grip achieved by the contact pressure.

The cutting device 4, shown in FIG. 2 and FIG. 3, is designed as an oscillating knife. The cutting device 4 is arranged over the discharge belt 3 in the discharge region 17 of the device. The course of the cutting device 4 is aligned parallel to the course of the discharge belt 3 and is linearly adjustable in the cutting plane. The cutting device 4 can be adjusted vertically or more specifically in the vertical distance from the surface 3′ of the discharge belt 3 and, thus, determines the height of the strip of dough 22. The cutting edge 23 of the cutting device 4 is located, when viewed in the vertical direction of the discharge belt 3, above the discharge belt 3 and its surface 3′.

FIG. 4 shows a side view of the drive side of the device 10 for forming a continuous strip of dough. FIG. 4 shows a drive 7 that is designed as an electric motor. The drive 7 is connected to the drive rollers 9 of the discharge belt 3 and the limiting belt 5 by means of a chain drive with chain 18. The drive 7 drives the chain 18, which in turn puts the drive rollers 9 into motion.

An additional embodiment of the cutting device 4 is shown in FIG. 4. The cutting device 4 is pivotably mounted about the center point of the limiting plates 1a, 1b. The pivoting of the cutting device 4 is accomplished by an actuating device 19 by means of a gearwheel. A very precise adjustment of the height of the strip of dough 22 is achieved by adjusting the cutting device 4 about the center point of the limiting plates 1a, 1b. Furthermore, this arrangement prevents the cutting device 4 from plunging into a section of the dough chamber 2 that is defined by the limiting plates 1a, 1b, and from colliding with them. The position of the cutting edge 23 of the cutting device 4 can also be finely adjusted or further varied by adjusting the cutting device 4 in the cutting plane.

FIG. 5 shows the device 10 in the unfolded state. The rigid frame structure 13 is connected to the housing 12 by means of hinges 24. The hinges 24 allow the rigid frame structure 13 and, connected thereto, the limiting plate 1a and the connecting part 6a to be unfolded. In the unfolded state the device 10 can be freed from any residual dough and can be serviced or more specifically cleaned more easily. In the closed state the rigid frame structure 13 is closed by means of snap locks 20 on the housing 12 (FIG. 1). In order to open the device 10, the snap locks 20 are opened, and the rigid frame structure 13 is pivoted about the hinges 24.

FIG. 6 shows the device 10 in the filled state. The dough chamber 2 is partially filled with dough 21. In the discharge region 17 of the device 10 FIG. 6 shows a strip of dough 22 that has already been partially formed. The height of the strip of dough 22 is defined by the distance of the cutting edge 23 of the cutting device 4 from the discharge belt 3. The cutting edge 23 extends parallel to the surface 3′ of the discharge belt 3.

As an alternative to the above described embodiment of the cutting device 4, the cutting device 4 may also be designed as an oscillating hacksaw or an ultrasonic cutting device. The cutting edge 23 may also project laterally beyond the two limiting plates 1a, 1b.

As an alternative, the limiting plates 1a, 1b may comprise teeth on their periphery teeth and may be driven with the discharge belt 3 and the limiting belt 5 by way of a form fit. Similarly the limiting plates 1a, 1b may be driven by the drive 7, and owing to the movement coupling with the limiting belt 5 and the discharge belt 3 may drive said belts. As an alternative to the aforementioned chain drives by means of belts or toothed belts, the drive 7 may also be connected to the drive rollers 9 or more specifically to the limiting plates 1a, 1b.

As an alternative, instead of the devices 14b, 14b for producing a film of oil, it is also possible to provide flour dusting devices that dust then the belts 3, 5 and/or the limiting plates 1a, 1b with flour as an anti-sticking agent, in order to make it easier to peel off the dough.

The cutting edge 23 of the cutting device 4 may also be arranged, as seen over the cross section, obliquely to the discharge belt 3, for example, slanted or skewed relative to the discharge belt 3 and, as a result, can achieve a varying cross section of the strip of dough 22.

At this point the functionality or more specifically the practical application of the device 10 will be described by means of a preferred embodiment only for illustrative purposes.

In the present example the dough chamber 2 of the device 10 (FIG. 6) is filled with dough by hand or by means of a large dough hopper, which cuts portions by means of star rollers. The dough 21 is rotated by means of the driven limiting belt 5 and the discharge belt 3, together with the limiting plates 1a, 1b that are driven by said belts, and the individual lumps of dough are mixed together and connected and conveyed in the direction of the cutting device 4. The discharge belt 3 conveys the dough 21 towards the cutting device 4. In the discharge region 17 of the device 10, the dough 21 is cut off vertically by the cutting device 4 and is conveyed by means of the discharge belt 3 out of the device 10 as a strip of dough 22. The excess dough accumulating at the cutting device 4 is moved further by means of the limiting belt 5 and is mixed again in the dough chamber 2 with the dough 21 introduced therein. When the level of the dough drops in the dough chamber 2, new dough 21 may be introduced into the device 10, and, as a result, a strip of dough 22 of virtually infinite length is formed continuously.

The width of the strip of dough 22 may be set and varied by adjusting the limiting plates 1a, 1b and/or the connecting parts 6a, 6b while the system is running or when the system has stopped. The adjustment of the cutting device 4 has the effect of changing the height of the strip of dough 22, and this adjustment can be made either when the device 10 has stopped or while the device is running. After the discharge belt 3 has moved the strip of dough 22 out of the device 10, the strip of dough 22 may be delivered to an additional conveyor belt and may be passed on to other devices for processing.

FIG. 7 shows an advantageous alternative embodiment of the invention, where in this case the limiting belt 5 has a section that runs between the two limiting plates 1a, 1b. For this purpose the guide roller 11′ in the region 30 of the periphery of the limiting plates 1a, 1b is disposed on the peripheral edge or more specifically in the region of the peripheral edge or inside the chamber 2, defined by the limiting plates 1a, 1b, and, in particular, above the cutting device. 4

The limiting belt 5 is defined advantageously by at least one of the guide rollers 11, 11′, 11″. The drive takes place by means of the roller 9. The angle of the limiting belt 5 is adjusted relative to the vertical X-X by means of the roller 11″. This additional roller 11″ may be located between the two limiting plates 1a, 1b or also outside or more specifically above the dough chamber 2, defined by two limiting plates 1a, 1b.

In FIG. 7, +A, −A denotes the angle, which can be assumed by the limiting belt 5 or more specifically its section, starting from the guide roller 11′, with the vertical. The angle +A or −A respectively may be up to 30°, preferably up to 15°, in particular, up to 5°, respectively.

The advantage of the limiting belt 5, which runs between the limiting plates 1a, 1b inside the dough chamber 2, is that the dough piling up in front of the discharge gap can be quickly thrown back and returned again to the gap or recycled for the formation of a strip. This arrangement prevents the dough from piling up too much along the limiting belt 5 or from being carried along too long by said limiting belt.

The belt between the guide rollers 11′, 11″ is advantageously guided so as to be tight, as a result of which the rejection of the dough piling up in front of the gap or the cutting device 4 respectively is improved.

The guide roller 11″ is advantageously at a level in the dough chamber 2 or more specifically between the limiting plates 1a, 1b that is 50 to 80% of the diameter of the limiting plates 1a, 1b, where in this case this level is measured from the lowest point of the limiting plates 1a, 1b.

The guide roller 11′ is located as close as possible to the peripheral edge of the two limiting plates 1a, 1b between these two plates. The respective ends of the limiting belt 5 or the side edges of the limiting belt 5 respectively lie as close as possible to the limiting plates 1a, 1b, in order to prevent as well as possible the dough from escaping.

It may also be provided that the side edges of the limiting belt 5 rest exactly against the inner surface of the limiting plates 1a, 1b.

Furthermore, it is provided that the devices for producing a film of oil 14b extend at least up to the middle or by about 10% of the radius beyond said middle, in order to achieve the objective that a sufficient amount of oil is produced on the inner surface of the limiting plates 1a, 1b. Hence, the devices for producing a film of oil 14 extend advantageously at least over the entire radius of the limiting plates 1a, 1b and are supported on said limiting plates in the center of the limiting plates 1a, 1b.

It is particularly advantageous, if the section of the limiting belt 5 between the guide roller 11′ and the guide roller 11″ extends vertically.

In order to make it possible to adapt the angle A of the limiting belt 5 to the vertical, it may be provided that the guide roller 11″ is laterally adjustable in the horizontal direction or more specifically in its position above the guide roller 11′ in or counter to the conveying direction of the discharge belt 3. As a result, the angle +A, −A can be adjusted.

Even in the case of this embodiment it is possible to adjust the width of the limiting plates 1a, 1b. However, this width adjustment is associated with the inclusion or rather the insertion of a limiting belt 5 having a suitably modified width.

1. A device for forming a continuous strip of dough, characterized in that the device (10) comprises a dough chamber (2), which is defined in sections by a discharge belt (3) for conveying dough towards a cutting device (4) for limiting the thickness of the strip of dough, wherein the cutting device (4) is mounted at a distance above the discharge belt (3).

2. A device, as claimed in claim 1, characterized in that two opposite, rotatably mounted limiting plates (1a, 1b) are provided, wherein the limiting plates (1a, 1b) define the dough chamber (2) laterally.

3. A device, as claimed in claim 2, characterized in that the limiting plates (1a, 1b) rest on or against the discharge belt (3).

4. A device, as claimed in claim 2, characterized in that the limiting plates (1a, 1b) are oriented perpendicular to the surface (3′) of the discharge belt (3), and/or that the dough chamber (2) is designed so as to be cylindrical, and/or the limiting plates (1a, 1b) are designed so as to be round.

5. A device, as claimed in claim 4, characterized in that the axis of the cylindrical dough chamber (2) is arranged horizontally and parallel to the surface (3′) of the discharge belt (3).

6. A device, as claimed in claim 2, characterized in that the limiting plates (1a, 1b) have the same diameter and are aligned parallel and concentrically to each other.

7. A device, as claimed in claim 2, characterized in that the distance, in particular, the normal spacing, of the two limiting plates (1a, 1b) from each other is adjustable, for adjusting the width of the strip of dough (22).

8. A device, as claimed in claim 2, characterized in that both limiting plates (1a, 1b) are movable, independently or coupled, preferably synchronously, toward each other.

9. A device, as claimed in claim 2, characterized in that a number of connecting parts (6a, 6b) are provided, which can be connected to the limiting plates (1a, 1b) in their peripheral region, are aligned preferably parallel to the limiting plates (1a, 1b), and define the dough chamber (2).

10. A device, as claimed in claim 1, characterized in that the discharge belt (3) is disposed in the region (2′) of the dough chamber (2) that is located at the bottom when in use.

11. A device, as claimed in claim 1, characterized in that the cutting device (4) has a cutting edge (23), and the distance of the cutting edge (23) of the cutting device (4) from the discharge belt (3) is adjustable, for adjusting the height of the strip of dough (22).

12. A device, as claimed in claim 2, characterized in that the cutting device (4) is pivotably mounted about the central axis of the limiting plates (1a, 1b).

13. A device, as claimed in claim 1, characterized in that the cutting edge (23) of the cutting device (4) extends transversely to the direction of movement of the discharge belt (3) and parallel to the surface (3′) of the discharge belt (3).

14. A device, as claimed in claim 1, characterized in that the cutting edge (23) of the cutting device (4) is linearly adjustable in the cutting plane.

15. A device, as claimed in claim 2, characterized in that the cutting device (4) has at least the same width as or a greater width than the, preferably maximum, internal distance between the limiting plates (1a, 1b).

16. A device, as claimed in claim 1, characterized in that the cutting device (4) is designed as an oscillating hacksaw, an oscillating knife or an ultrasonic cutting device.

17. A device, as claimed in claim 1, characterized in that at least one limiting belt (5) is provided, which is connected, in particular, directly to the cutting device (4), when viewed in the direction of rotation of the limiting plates (1a, 1b), and defines the dough chamber (2).

18. A device, as claimed in claim 2, characterized in that the discharge belt (3) and/or the limiting belt (5) loop(s), in particular, in sections, around the limiting plates (1a, 1b), preferably on the periphery thereof, and/or can be brought into contact with the connecting parts (6a, 6b).

19. A device, as claimed in claim 2, characterized in that the contact pressure of the discharge belt (3) and/or the limiting belt (5) can be predetermined by the position of the limiting plates (1a, 1b), the connecting parts (6a, 6b) and/or the guide rollers (11).

20. A device, as claimed in claim 1, characterized in that a drive (7) is provided, and the discharge belt (3), the limiting belt (5) and/or the limiting plates (1a, 1b) can be driven by means of this drive (7).

21. A device, as claimed in claim 20, characterized in that the discharge belt (3) and/or the limiting belt (5) comprise(s) at least one drive roller (9), wherein the drive roller (9) is connected to the drive (7) by way of chains (18), belts, or toothed belts.

22. A device, as claimed in claim 2, characterized in that the limiting plates (1a, 1b) are connected in a movement coupled manner on their periphery to the discharge belt (3) and/or to the limiting belt (5) by means of a friction grip or by means of teeth, formed on the periphery of the limiting plates (1a, 1b).

23. A device, as claimed in claim 2, characterized in that a housing (12) is provided, and the limiting plates (1a, 1b), the guide rollers (11) or the drive rollers (9) are mounted in the housing in a manner allowing rotation, in particular, in a floating manner.

24. A device, as claimed in claim 23, characterized in that the housing (12) comprises a rigid frame structure (13), wherein the limiting plates (1a, 1b) are mounted in the rigid frame structure (13).

25. A device, as claimed in claim 23, characterized in that the rigid frame structure (13) and/or the housing (12) comprise(s) a number of hinges (24), and/or at least one of the limiting plates (1a, 1b) and/or the connecting parts (6a, 6b) can be detached or swung away from the rigid frame structure (13) with the hinges (24), in order to facilitate the cleaning of the dough chamber (2).

26. A device, as claimed in claim 1, characterized in that a number of devices for producing a film of oil (14a, 14b) and/or flour dusting devices are provided, with which edible oil or flour can be applied to the inner faces of the limiting plates (1a, 1b) and/or to the limiting belt (5) and/or to the discharge belt (3) as an anti-sticking agent.

27. A device, as claimed in claim 1, characterized in that the limiting belt (5) is guided upwards through the space, located between the limiting plates (1a, 1b), or more specifically through the dough chamber (2) by the guide roller (11′) that is in close proximity to the cutting device (4).

28. A device, as claimed in claim 27, characterized in that the guide roller (11′) is situated between the two limiting plates (1a, 1b) or more specifically is disposed inside the dough chamber (2).

29. A device, as claimed in claim 27, characterized in that the belt section of the limiting belt (5) that lies between the guide rollers (11′, 11″) encloses with the vertical an angle between −A or +A, respectively of at most 30°, preferably 15°, in particular, 5°.

30. A device, as claimed in claim 27, characterized in
that the limiting belt (5) moves from the guide roller (11′) to the guide roller (11″) and/or
that the guide roller (11′) is parallel to the cutting edge (23).

31. A device, as claimed in claim 27, characterized in that the guide roller (11″) is located at a height level that is 50 to 80% of the diameter of the limiting plates (1a, 1b), wherein this level is measured from the lowest point of the limiting plates (1a, 1b).

32. A device, as claimed in claim 27, characterized in that the guide roller (11″) is laterally adjustable in the horizontal direction or more specifically in its position above the guide roller (11′) in or counter to the conveying direction of the discharge belt (3).

33. A method for forming a continuous strip of dough, in particular with a device, as claimed in claim 1, characterized in that the dough is delivered into a dough chamber (2), and dough is conveyed continuously by a discharge belt (3) towards a cutting device (4); and the cutting device (4) cuts off the dough at a distance from the discharge belt (3) at a predetermined height; and that the dough portion of the delivered amount of dough that exceeds a predetermined height is cut off with the cutting device (4); is conveyed, in particular, back into the dough chamber (2) or is retained in the dough chamber (2); and the severed strip of dough (22) is discharged from the dough chamber (2).

34. A method, as claimed in claim 33, characterized in that in a preparation step dough portions are introduced into the dough chamber (2), where they are connected to form a dough mass.

35. A method, as claimed in claim 33, characterized in that the cut of the cutting device (4) is carried out transversely and parallel to the direction of movement of the discharge belt (3).
